(19) United States
(12) Patent Application Publication
(10) Pub. No.: US 2025/0304393 A1
(43) Pub. Date: Oct. 2, 2025

(54) PRINTING APPARATUS

(71) Applicant: SEIKO EPSON CORPORATION, Tokyo (JP)

(72) Inventor: Hiroyuki ENDO, SHIOJIRI-SHI (JP)

(21) Appl. No.: 19/089,932

(22) Filed: Mar. 25, 2025

(30) Foreign Application Priority Data
Mar. 27, 2024 (JP) 2024-051232

(51) Int. Cl. B65H 23/18; B41J 3/407; B41J 11/00; B65H 20/02

(52) U.S. Cl. CPC B65H 23/18; B41J 3/4075; B41J 11/0095; B65H 20/02; B65H 2301/44318; B65H 2557/266; B65H 2701/192; B65H 2801/27

(57) ABSTRACT

A printing apparatus includes a print head, a peeling unit that peels a label from backing paper, a transport roller disposed upstream of the peeling unit on a transport path of label paper, a peeling roller disposed downstream of the peeling unit on a transport path of the backing paper, a detection unit that detects an end position of the label paper, and a control unit, the peeling unit includes a peeling plate that can rotate on the same plane as a surface of the label paper with a rotation shaft as a fulcrum, and a third motor that rotates the peeling plate with a support shaft as a fulcrum, and the control unit performs feedback control on the third motor based on a detection result of the detection unit so that a variation in the end position of the label paper is reduced.

The present application is based on, and claims priority from JP Application Serial Number 2024-051232, filed Mar. 27, 2024, the disclosure of which is hereby incorporated by reference herein in its entirety.

### BACKGROUND

### 1. Technical Field

The present disclosure relates to a printing apparatus.

### 2. Related Art

In the related art, a printing apparatus including a label peeling mechanism is known. In the printing apparatus including the label peeling mechanism, when a tension becomes larger than a transport force, a transport force generated by a transport roller becomes large, and slippage occurs between the transport roller and label paper, a label paper holding force of the transport roller becomes weak, and meandering and skewing occur.

For example, in a printing apparatus disclosed in JP-A-2023-106036, a tension of label paper between a transport roller and a peeling roller is kept constant so that the tension does not exceed a label paper holding force of the transport roller.

However, even if the transport force of the peeling roller is set and controlled not to exceed a label holding force of the transport roller, the balance of the tension is lost and a slight slip occurs, and thus meandering or skew may occur when a disturbance acts.

### SUMMARY

An aspect for solving the problem is a printing apparatus including: a print head configured to perform printing on label paper obtained by attaching a label to a backing paper, a peeling unit configured to peel the label from the backing paper, a first roller disposed upstream of the peeling unit in a transport path of the label paper, a second roller disposed downstream of the peeling unit in a transport path of the backing paper, a detection unit configured to detect an end position of the label paper, and a control unit, wherein the peeling unit includes a peeling plate rotatable on the same plane as a paper surface of the label paper with a support shaft as a fulcrum, and a peeling plate driving unit configured to rotate the peeling plate with the support shaft as a fulcrum, and the control unit performs feedback control on the peeling plate driving unit based on a detection result of the detection unit so that a variation in the end position of the label paper is reduced.

### BRIEF DESCRIPTION OF THE DRAWINGS

FIG. 1 illustrates a configuration of a label printer.

FIG. 2 is a diagram illustrating a partial range including a transport roller and a peeling roller.

FIG. 3 is a diagram illustrating factors causing disturbance.

FIG. 4 is a diagram illustrating a rotation mechanism for rotating a peeling plate.

FIG. 5 is a diagram illustrating a configuration of a control unit.

FIG. 6 is a diagram illustrating variables related to transport of label paper.

FIG. 7 is a block diagram illustrating modeled label paper transport control.

FIG. 8 is a diagram illustrating simulation results.

FIG. 9 is a diagram illustrating simulation results.

FIG. 10 is a flowchart illustrating an operation.

### DESCRIPTION OF EMBODIMENTS

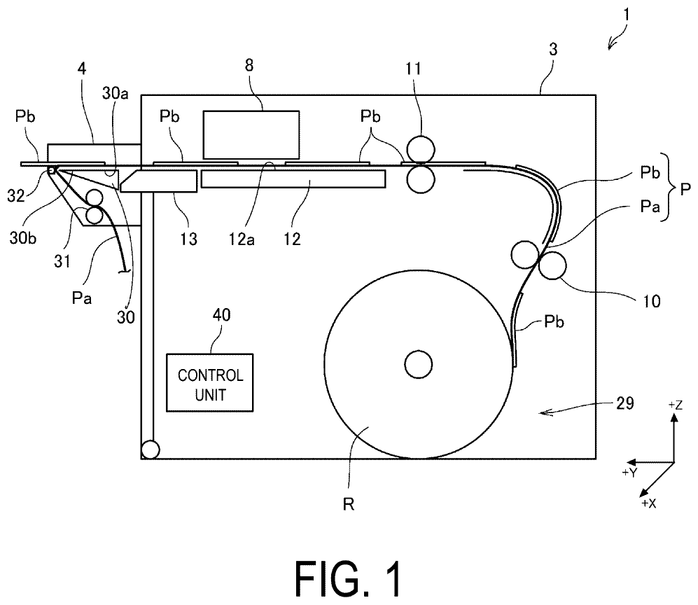

FIG. 1 is a diagram illustrating an example of an overall configuration of a label printer 1 according to the present embodiment.

FIG. 1 shows an X-axis, a Y-axis, and a Z-axis. The X-axis, the Y-axis, and the Z-axis are orthogonal to each other. The Z-axis indicates an up-down direction and a vertical direction in an installed state of the printing apparatus 1. The X-axis and the Y-axis are parallel to a horizontal direction. The Y-axis indicates a left-right direction of the printing apparatus 1. In the printing apparatus 1, a side on which the peeling unit 4 is disposed is a front side in a front-rear direction. The X-axis indicates the left-right direction of the printing apparatus 1. The left-right direction of the printing apparatus 1 is a width direction of a printing medium S. A positive direction of the Z-axis indicates an upward direction. A positive direction of the Y-axis indicates a frontward direction. A positive direction of the X-axis indicates a right direction.

The label printer 1 is a printer that prints characters, images, figures, and the like using label paper P as a print medium by using, for example, an inkjet scheme. The label printer 1 corresponds to a printing apparatus.

The label paper P includes backing paper Pa and a plurality of labels Pb. The backing paper Pa is a strip-shaped continuous sheet. Peelability is applied to a surface of the backing paper Pa, and labels Pb cut into a predetermined size are stuck at equal intervals in a longitudinal direction of the backing paper Pa. A material of the backing paper Pa and the label Pb may be paper or may be a material other than paper. The label paper P is set in the label printer 1 as roll paper R wound in a roll shape.

The label printer 1 includes a printing unit 3 as a main body of the label printer 1 and a peeling unit 4. The peeling unit 4 may be formed integrally with the printing unit 3 or may be a component attachable to and detachable from the printing unit 3.

The peeling unit 4 is a device that performs processing of peeling the label Pb from the backing paper Pa with respect to the label paper P printed on by the printing unit 3, and is also referred to as a peeler. The label printer 1 can execute a non-peeling mode in which the printed label paper P with the label Pb attached to the backing paper Pa is discharged and a peeling mode in which the printed label Pb peeled off from the backing paper Pa is discharged. In the present embodiment, the peeling mode will be described.

The printing unit 3 performs printing on each label Pb of the label paper P using the print head 8 based on a command transmitted from a computer (not illustrated) and print data. The printing unit 3 transports the label paper P along a transport path of the label paper P. Hereinafter, upstream and downstream of the transport path may be simply referred to as upstream and downstream.

As illustrated in FIG. 1, the printing unit 3 includes an accommodation unit 29, a feeding roller 10, a transport roller 11, a platen 12, a guide 13, a print head 8, and a control unit 40. The transport roller 11 corresponds to a first roller.

The accommodation unit 29 is a space for accommodating the roll paper R, and the label paper P is fed out from the roll paper R set in the accommodation unit 29. The feeding roller 10 is configured of a pair of rollers disposed to face each other, and transports the label paper P fed from the roll paper R downstream.

The transport roller 11 is configured of a pair of rollers disposed to face each other, nips the label paper P transported by the feeding roller 10, and transports the label paper P toward the print head 8 on the downstream side.

The feeding roller 10 is coupled to a feeding motor (not shown) and is rotated by power of the feeding motor. The transport roller 11 is coupled to the first motor M1 directly or via a gear, a belt, or the like, and rotates by the power of the first motor M1.

The platen 12 is disposed downstream of the transport roller 11 in the transport path of the label paper P. A platen surface 12a which is an upper surface of the platen 12 comes into contact with the backing paper Pa of the label paper P and supports the label paper P from below. A plurality of air intake holes (not shown) are formed in the platen surface 12a. Each of the suction holes communicates with a suction fan (not shown). When the suction fan operates, air is sucked from the suction holes, and the label paper P is sucked to the platen surface 12a.

The print head 8 is disposed to face the platen surface 12a. The print head 8 includes nozzle arrays (not shown) corresponding to one or a plurality of colors of ink, and ejects ink from nozzles constituting each nozzle array. The print head 8 performs printing on the label Pb by ejecting ink to the label Pb positioned on the platen surface 12a based on the print data. The label paper P printed on by the print head 8 is transported to the peeling unit 4 on the downstream side by the transport roller 11.

In the present embodiment, a case in which the label printer 1 performs printing on the label Pb using an ink jet scheme will be described, but the present disclosure is not limited to the ink jet scheme.

The guide 13 is disposed downstream of the print head 8. The guide 13 supports the label paper P printed on by the print head 8 from below between the platen 12 and the peeling unit 4. The label paper P is transported toward the peeling unit 4 on the downstream side on the guide 13.

The peeling unit 4 includes a peeling plate 30 and a peeling roller 31. The peeling plate 30 is located downstream of the guide 13 of the printing unit 3. The peeling plate 30 includes a guide surface 30a which comes into contact with the backing paper Pa of the label paper P and supports the label paper P from below, and a peeling edge 30b having an acute angle formed at the tip of the guide surface 30a. The label paper P guided by the guide 13 is transported onto the guide surface 30a of the peeling plate 30.

The peeling roller 31 is configured by a pair of rollers disposed to face each other, and nips and transports the backing paper Pa. The peeling roller 31 is coupled to the second motor M2 directly or via a gear, a belt, or the like, and rotates by the power of the second motor M2. The peeling roller 31 corresponds to a second roller.

When the label printer 1 is operated in the peeling mode, an operation of causing the peeling roller 31 to nip the backing paper Pa of the label paper P is performed by the user before printing is started. The peeling roller 31 is disposed below the peeling plate 30, and nips and transports the backing paper Pa downward. The backing paper Pa of the label paper P transported on the guide surface 30a is bent at the peeling edge 30b and pulled downward by the peeling roller 31. Due to a pulling force of the peeling roller 31, the label Pb is lifted from the backing paper Pa at the peeling edge 30b and peeled off. The peeled label Pb protrudes leftward from the peeling unit 4 in FIG. 1. The label Pb protruding from the peeling unit 4 is collected by the user. On the other hand, the backing paper Pa transported by the peeling roller 31 in a direction different from that of the label Pb is discharged below the peeling roller 31.

In the configuration described above, the transport path of the label paper Pis formed in the printing unit 3 by the feeding roller 10, the transport roller 11, the platen 12, the guide 13, and the guide surface 30a of the peeling plate 30. The peeling edge 30b and the peeling roller 31 form a part of a transport path of the backing paper Pa.

The control unit 40 controls operations of the respective units of the label printer 1. In the present embodiment, the control unit 40 controls driving of the transport roller 11 and the peeling roller 31. That is, the control unit 40 controls the first motor M1, the second motor M2, and the third motor M3.

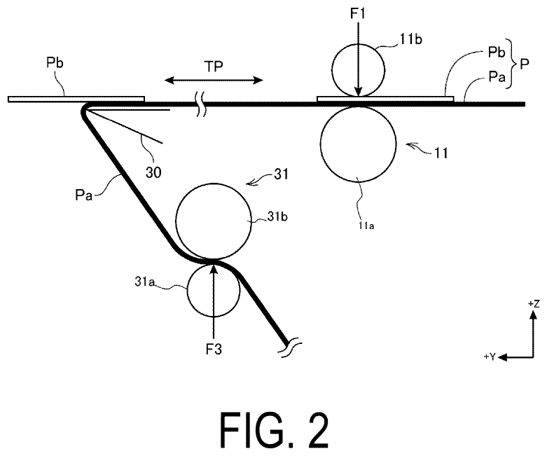

FIG. 2 is a diagram illustrating a partial range including the transport roller 11 and the peeling roller 31.

The transport roller 11 includes a first driving roller 11a and a first driven roller 11b that nips the label paper P. The first motor M1 drives the first driving roller 11a so that the first driving roller 11a rotates. The first driven roller 11b is supported to be rotatable according to transport of the label paper P due to rotation of the first driving roller 11a.

The peeling roller 31 includes a second driving roller 31a and a second driven roller 31b that nip the backing paper Pa of the label paper P. The second motor M2 drives the second driving roller 31a so that the second driving roller 31a rotates. The second driven roller 31b is rotatably supported according to the transport of the backing paper Pa due to the rotation of the second driving roller 31a.

In the transport roller 11, the first driven roller 11b presses the first driving roller 11a with a force F1 in order to nip the label paper P. That is, the first driving roller 11a is pressed by the force F1 in a direction substantially perpendicular to an orientation of the label paper P at a point of contact with the label paper P, and the label paper P is held by the transport roller 11.

In the peeling roller 31, the second driven roller 31b presses the second driving roller 31a with a force F3 in order to nip the backing paper Pa. That is, the second driving roller 31a is pressed by the second driven roller 31b with the force F3 in a direction substantially perpendicular to a traveling direction of the backing paper Pa at a point of contact with the backing paper Pa.

The tension TP is a tension applied to the label paper P between the transport roller 11 and the peeling roller 31. The tension TP is controlled by controlling the driving of the first motor M1. For example, the control unit 40 controls the generated torque generated by the first motor M1 so that the tension TP matches the target value of the tension.

However, even if the number of rotations of the first motor M1 and the second motor M2 is controlled so that a transport force of the peeling roller 31 does not exceed a holding force of the label paper P of the transport roller 11, the balance of the tension is lost and slight slippage occurs when disturbance or the like acts, and thus meandering, oblique transport, or the like may occur.

Factors causing the disturbance include a position of the label paper P with which the first driving roller 11a comes into contact and a load balance applied to the label paper P by the first driving roller 11a. Further, the position of the label paper P in contact with the second driving roller 31a and the load balance applied to the label paper P by the second driving roller 31a also become factors of disturbance.

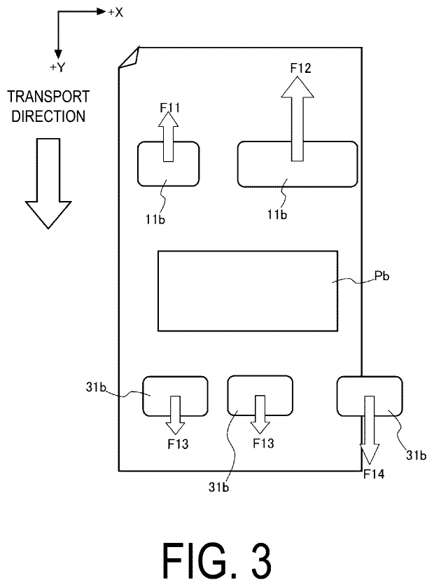

FIG. 3 is an illustrative diagram illustrating factors of disturbance.

FIG. 3 is a diagram illustrating the first driven roller 11b and the second driven roller 31b that come into contact with the label paper P.

In the example illustrated in FIG. 3, two first driven rollers 11b are disposed side by side in a width direction of the label paper P, but the sizes of the two first driven rollers 11b in the width direction are different, and areas of the two first driven rollers 11b in contact with the label paper P are also different. Therefore, the forces F11 and F12 applied to the label paper P by the two first driven rollers 11b are different from each other, and the load balance varies.

Further, FIG. 3 illustrates an example in which three second driven rollers 31b having the same size in the widthwise direction are disposed side by side in the width direction of the label paper P. The second driven rollers 31b disposed on the left side and the center are disposed on the label paper P in the figure, but the second driven roller 31b disposed on the right side is in a state in which only a part thereof overlaps the label paper P in the figure. Even in such a case, the force F13 exerted on the label paper P by the second driven rollers 31b disposed on the left side and the center is different from the force F14 exerted on the label paper P by the second driven roller 31b disposed on the right side. This causes a variation in load balance. Therefore, in the present embodiment, a deviation amount of the label paper P in the width direction is measured by the detection unit 50, and an angle of the peeling plate 30 is controlled based on the measured deviation amount.

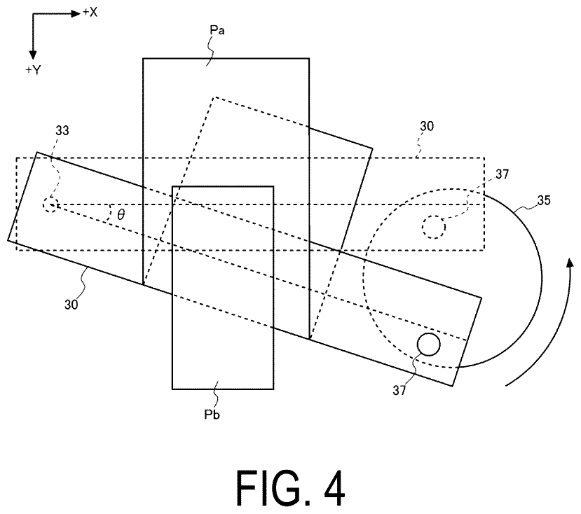

FIG. 4 is a diagram illustrating a rotation mechanism for rotating the peeling plate 30.

A rotation shaft 33 is provided at a left end of the peeling plate 30 in the figure. The rotation shaft 33 corresponds to a support shaft.

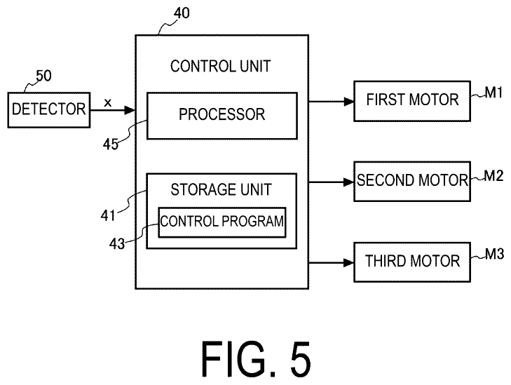

Further, a cam 35 and a support shaft 37 are provided at a right end portion of the peeling plate 30 in the figure. The cam 35 is driven and rotated by the third motor M3 illustrated in FIG. 5. The support shaft 37 is coupled to the cam 35 and the peeling plate 30 and rotates with the rotation of the cam 35. When the cam 35 rotates, the peeling plate 30 rotates about the rotation shaft 33. A rotation angle θ of the peeling plate 30 is controlled based on a rotation amount of the third motor M3 controlled by the control unit 40. The third motor M3, the rotation shaft 33, the cam 35, and the support shaft 37 correspond to a peeling plate driving unit.

FIG. 5 is a diagram illustrating a configuration of the control unit 40.

The control unit 40 is a computer device including a storage unit 41 and a processor 45.

The storage unit 41 is configured of, for example, a nonvolatile semiconductor memory or a volatile and nonvolatile semiconductor memory. The storage unit 41 stores a control program 43.

The processor 45 is a calculation processing device configured of a central processing unit (CPU) or a micro processing unit (MPU). The processor 45 may be configured of a single processor or may be configured of a plurality of processors.

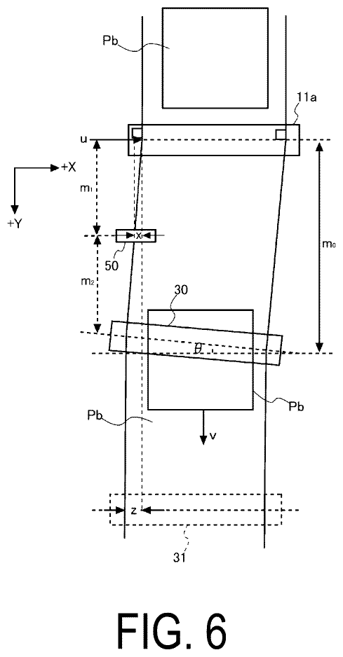

Measurement data measured by the detection unit 50 is output to the control unit 40. The detection unit 50 outputs the deviation amount of the label paper P in a width direction as measurement data. As illustrated in FIG. 6 to be described later, the detection unit 50 is disposed between the first driven roller 11b and the peeling plate 30.

The control unit 40 controls the rotation direction and the rotation amount of the third motor M3 based on the input measurement data to control the angle θ of the peeling plate 30. The angle θ is a rotation angle of the peeling plate 30 in the same plane as ae paper surface of the label paper P with the rotation shaft 33 as a fulcrum.

FIG. 6 is a diagram illustrating variables related to the transport of the label paper P.

The following variables are defined:
m₀ is a variable indicating a distance from the first driving roller 11a to the peeling plate 30.
m₁ is a variable indicating a distance from the first driving roller 11a to the detection unit 50.
m₂ is a variable indicating a distance from the detection unit 50 to the peeling plate 30.
u is a variable indicating the position of the label paper P on the first driving roller 11a. In particular, a position of a left end of the label paper P on the first driving roller 11ab in a figure view is denoted by u in the figure.
x is a value detected by the detection unit 50 and is a variable indicating the position of the label paper P on the detection unit 50. In particular, a difference between a position of the left end of the label paper P on the first driving roller 11a and the left end of the label paper P on the detection unit 50 corresponds to the variable x in the figure.
z is a variable indicating the position of the label paper P on the peeling roller 31. In particular, a difference between the position of the left end of the label paper P on the first driving roller 11a and the left end of the label paper P on the peeling roller 31 corresponds to a variable z in the figure. θ is a variable indicating a rotation angle of the peeling plate 30. V is a variable indicating a transport speed of the label paper.

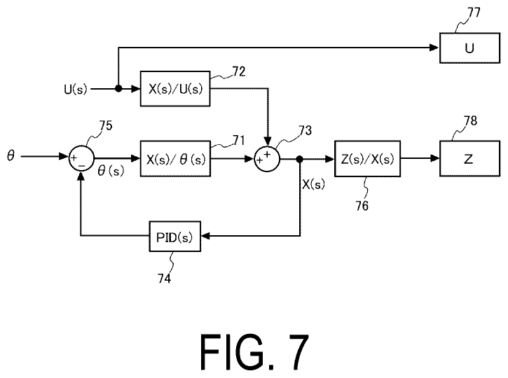

FIG. 7 is a block diagram in which transport control of the label paper P is modeled.

The block diagram includes three calculation blocks 71, 72, and 76, two calculation points 75 and 73, output blocks 77 and 78, and a PID control block 74. The output blocks 77 and 78 are blocks for outputting processing results.

The calculation block 71 is a block in which the relationship between the angle θ and the variable x is defined. A transfer function X(s)/θ (s) that defines the relationship between the angle θ and the variable x is set in the calculation block 71. S denotes a complex number.

The output θ (s) of the calculation point 75 is input to the calculation block 71. The calculation block 71 outputs the function X(s) of the complex number s based on the input function θ(s) of the complex number s and the transfer function X(s)/θ (s). The function X(s) of the complex number s output from the calculation block 71 is input to the calculation point 73.

The calculation block 72 is a block in which a relationship between the disturbance u and the variable x is defined. A transfer function X(s)/U(s) that defines a relationship between the disturbance u and x is set in the calculation block 72. A function U(s) of the complex number s of the disturbance u is input to the calculation block 72. The calculation block 72 outputs the function X(s) of the complex number s based on the input function U(s) of the complex number s of the disturbance u and the transfer function X(s)/U(s). The function X(s) of the complex number s output from the calculation block 72 is input to the calculation point 73.

The calculation point 73 adds the function X(s) of the complex number s input from the calculation block 71 and the function X(s) of the complex number s input from the calculation block 72. The calculation point 73 outputs the added function X(s) of the complex number s to the PID control block 74 and the calculation block 76.

The function X(s) of the complex number s, which is the output of the calculation point 73, is a function obtained by performing Laplace transform on the variable x indicating the position of the label paper P on the detection unit 50.

The calculation block 76 is a block that defines a relationship between the variable z and the variable x. In the calculation block 76, a transfer function Z(s)/X(s) is defined.

The function X(s) of the complex number s is input from the calculation point 73 to the calculation block 76. The calculation block 76 outputs the function Z(s) of the complex number s based on the input function X(s) of the complex number s and the transfer function Z(s)/X(s). An output of the calculation block 76 is input to an output block 78 as an output Z.

The function X(s) of the complex number s is input from the calculation point 73 to the PID control block 74. The PID control block 74 outputs a function θ (s) of the complex number s based on the input function X(s) of the complex number s.

For example, the PID control block 74 performs PID control using the following formula as a proportional coefficient P, an integral coefficient I, and a differential coefficient D.

$$P + I \times ( 1 / s ) + D \times s \qquad ( 1 )$$

The PID control block 74 of the present embodiment performs proportional control of P=0.2, I=0, and D=0. Therefore, the function θ (s) of the complex number s output by the PID control block 74 is

$$θ ( s ) = 0.2 \cdot X ( s ) . \qquad ( 2 )$$

The function θ (s) of the complex number s is input to the calculation point 75 from the PID control block 74. The calculation point 75 subtracts the function θ (s) of the complex number s from the reference angle θ of the peeling plate 30, and outputs a subtraction result to the calculation block 71.

Next, a method of calculating the transfer function X(s)/θ (s) of the calculation block 71, the transfer function X(s)/U(s) of the calculation block 72, and the transfer function Z(s)/X(s) of the calculation block 76 will be described.

According to the description on page 163 of “Practical Web Handling” of Web Handling Technology Research Association (2020, CTI Processing Technology Research Association), Formula (3) below is established.

$$tan θ = ( u - z ) / {m}_{0} \qquad ( 3 )$$

Formula (4) below is established based on a right angle advancing property of the label paper (web).

$$\begin{matrix}[ Math . 1 ] & \\ \frac{dz}{dt} = v tan θ = \frac{v}{{m}_{0}} [ u - z ] & ( 4 )\end{matrix}$$

Here, when T=m₀/v is set and Laplace transform is performed and rearranged, Formula (5) below is established.

$$[ Math . 2 ]$$

$$\frac{Z ( s )}{U ( s )} = \frac{1}{1 + T s} \qquad ( 5 )$$

Further, since a relationship of dz/dt=vtan θ=vθ (6) is established, the transfer function Z(s) of z becomes Formula (7) below.

$$[ Math . 3 ]$$

$$sZ ( s ) = v θ ( s )$$

$$Z ( s ) = \frac{v}{s} θ ( s ) \qquad ( 7 )$$

Further, from the proportional calculation, Formulas (8) and (9) below are established.

$$[ Math . 4 ]$$

$$\frac{u - z}{{m}_{0}} = \frac{x - z}{{m}_{2}} \qquad ( 8 )$$

$$[ Math . 5 ]$$

$$x = \frac{{m}_{2}}{{m}_{0}} u + ( 1 - \frac{{m}_{2}}{{m}_{0}} ) z \qquad ( 9 )$$

Therefore, the function X(s) of the complex number s is expressed by Formula (10) below.

$$[ Math . 6 ]$$

$$X ( s ) = \frac{{m}_{2}}{{m}_{0}} U ( s ) + ( 1 - \frac{{m}_{2}}{{m}_{0}} ) Z ( s ) \qquad ( 10 )$$

When Z(s) shown in Formula (5) is replaced with Z(s) in Formula (10) and a relational formula between X(s) and U(s) is obtained, Formula (11) below is obtained.

$$[ Math . 7 ]$$

$$X ( s ) = \frac{1 + \frac{{m}_{2}}{{m}_{0}} Ts}{1 + Ts} U ( s ) \qquad ( 11 )$$

When a relational formula between X(s) and Z(s) is obtained by replacing U(s) shown in Formula (5) with U(s) shown in Formula (10), Formula (12) below is obtained.

$$[ Math . 8 ]$$

$$X ( s ) = ( 1 + \frac{{m}_{2}}{{m}_{0}} Ts ) Z ( s ) \qquad ( 12 )$$

Therefore, the relational formula between X(s) and Z(s) becomes Formula (13) below.

$$[ Math . 9 ]$$

$$\frac{Z ( s )}{X ( s )} = \frac{1}{1 + \frac{{m}_{2}}{{m}_{0}} Ts} \qquad ( 13 )$$

A relational formula between X(s) and θ(s) becomes Formula (14) below from Formula (13) and Formula (7).

$$[ Math . 10 ]$$

$$\frac{X ( s )}{θ ( s )} = ( 1 + \frac{{m}_{2}}{{m}_{0}} Ts ) \frac{v}{s} \qquad ( 14 )$$

Further, a relational formula between X(s) and U(s) becomes Formula (15) below from Formula (5) and Formula (11).

$$[ Math . 11 ]$$

$$\frac{X ( s )}{U ( s )} = \frac{1 + \frac{{m}_{2}}{{m}_{0}} Ts}{1 + Ts} \qquad ( 15 )$$

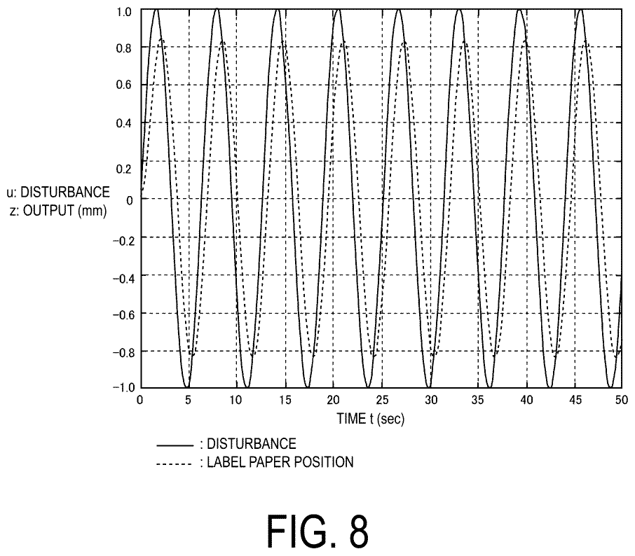

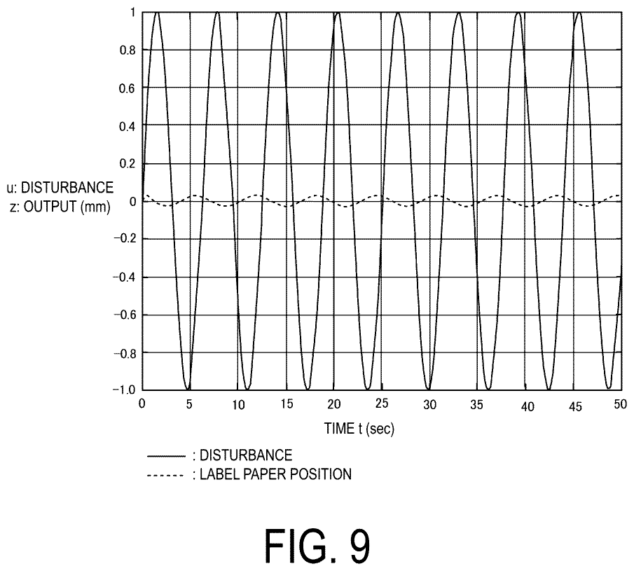

FIGS. 8 and 9 are diagrams illustrating simulation results.

FIG. 8 illustrates a simulation result showing a relationship between the disturbance u and a label paper position z when m0=100 mm, m1=50 mm, m2=50 mm, a transport speed v=150 mm/s, and the disturbance u is a sine waveform with an amplitude of 1 mm and a frequency 1 (rad/s). FIG. 8 shows a simulation result when PID control is not performed, and FIG. 9 shows a simulation result when the PID control is performed. In the PID control, simulation was performed as proportional control with P=0.2. A solid line illustrated in FIGS. 8 and 9 indicates a temporal change in the disturbance u, and a broken line illustrated in FIGS. 8 and 9 indicates a temporal change in the label paper position z.

As is clear from a comparison between FIG. 8 and FIG. 9, it is understood that a variation of the output z can be curbed to be small by performing the PID control.

FIG. 1θ is a flowchart illustrating an operation of the label printer 1.

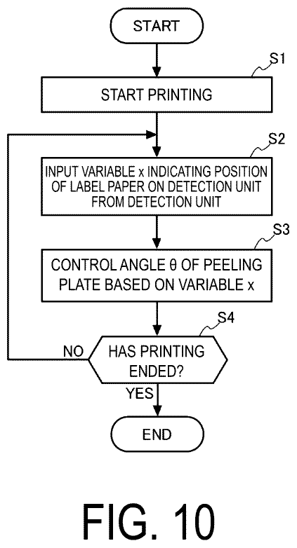

An operation of the label printer 1 will be described with reference to the flowcharts illustrated in FIG. 10.

First, when the control unit 40 starts the printing process (step S1), the control unit 40 detects the position of the label paper P in the width direction using the detection unit 50 (step S2).

Next, the control unit 40 controls the angle θ of the peeling plate 30 based on the variable x indicating the position of the label paper P on the detection unit 50 detected by the detection unit 50 (step S3). To be specific, the control unit 40 controls the angle θ of the peeling plate 30 based on a difference between a value obtained by multiplying the value of the variable x input from the detection unit 50 by 0.2 and a reference position (step S3).

Next, the control unit 40 determines whether the printing process has ended (step S4). When the printing process has not ended (step S4/NO), the control unit 40 returns to the process of step S2. Furthermore, when the printing process has ended (step S4/YES), the control unit 40 ends this processing flow.

### 4. Summary of Present Disclosure

Hereinafter, a summary of the present disclosure will be described.

### Appendix 1

A printing apparatus including: a print head configured to perform printing on label paper obtained by attaching a label to a backing paper, a peeling unit configured to peel the label from the backing paper, a first roller disposed upstream of the peeling unit in a transport path of the label paper, a second roller disposed downstream of the peeling unit in a transport path of the backing paper, a detection unit configured to detect an end position of the label paper, and a control unit, wherein the peeling unit includes a peeling plate rotatable on the same plane as a paper surface of the label paper with a support shaft as a fulcrum, and a peeling plate driving unit configured to rotate the peeling plate with the support shaft as a fulcrum, and the control unit performs feedback control on the peeling plate driving unit based on a detection result of the detection unit so that a variation in the end position of the label paper is reduced.

According to this configuration, since the peeling plate driving unit is subjected to feedback control so that the variation of the end position of the label paper is reduced even if disturbance or the like occurs, it is possible to control the transport direction of the label paper and reduce an amount of meandering and skew.

### Appendix 2

The printing apparatus according to appendix 1, wherein a function of a complex number s indicating a rotation angle θ of the peeling plate in the same plane as the paper surface of the label paper with the support shaft as a fulcrum is a function θ (s), a function of the complex number s indicating a position of the label paper on the first roller is a function U(s), a function of the complex number s indicating a position of the label paper on the peeling plate is a function X(s), a function of the complex number s indicating a position of the label paper on the second roller is a function Z(s), a distance from the first roller to the peeling plate is m₀, a distance from the first roller to the detection unit is m₁, and a distance from the detection unit to the peeling plate is m₂,

a transfer function indicating a relationship between a function X(s) of the complex number s and a function θ (s) of the complex number s is

$$[ Math . 12 ]$$

$$\frac{X ( s )}{θ ( s )} = ( 1 + \frac{{m}_{2}}{{m}_{0}} Ts ) \frac{v}{s} ,$$

a transfer function indicating a relationship between the function X(s) of the complex number s and the function U(s) of the complex number s is

$$[ Math . 13 ]$$

$$\frac{X ( s )}{U ( s )} = \frac{1 + \frac{{m}_{2}}{{m}_{0}} Ts}{1 + Ts} ,$$

a transfer function indicating a relationship between the function Z(s) of the complex number s and the function X(s) of the complex number s is

$$[ Math . 14 ]$$

$$\frac{Z ( s )}{X ( s )} = \frac{1}{1 + \frac{{m}_{2}}{{m}_{0}} Ts} ,$$

and T is a value obtained by dividing m₀ by a transport speed v of the label paper.

According to this configuration, since the peeling plate driving unit is subjected to feedback control so that the variation of the end position of the label paper detected by the detection unit is reduced, it is possible to control the transport direction of the label paper and reduce an amount of meandering and skew.

### Appendix 3

The printing apparatus according to appendix 1 or 2, wherein the detection unit is disposed between the first roller and the peeling plate.

According to this configuration, it is possible to detect the end position of the label paper between the first roller and the peeling plate using the detector.

What is claimed is:

1. A printing apparatus comprising:
a print head configured to perform printing on label paper obtained by attaching a label to a backing paper;
a peeling unit configured to peel the label from the backing paper;
a first roller disposed upstream of the peeling unit in a transport path of the label paper;
a second roller disposed downstream of the peeling unit in a transport path of the backing paper;
a detection unit configured to detect an end position of the label paper; and
a control unit, wherein
the peeling unit includes a peeling plate rotatable on the same plane as a paper surface of the label paper with a support shaft as a fulcrum; and
a peeling plate driving unit configured to rotate the peeling plate with the support shaft as a fulcrum; and
the control unit performs feedback control on the peeling plate driving unit based on a detection result of the detection unit so that a variation in the end position of the label paper is reduced.

2. The printing apparatus according to 1, wherein
a function of a complex number s indicating a rotation angle θ of the peeling plate in the same plane as the paper surface of the label paper with the support shaft as a fulcrum is a function θ (s), a function of the complex number s indicating a position of the label paper on the first roller is a function U(s), a function of the complex number s indicating a position of the label paper on the peeling plate is a function X(s), a function of the complex number s indicating a position of the label paper on the second roller is a function Z(s), a distance from the first roller to the peeling plate is m₀, a distance from the first roller to the detection unit is m₁, and a distance from the detection unit to the peeling plate is m₂,
a transfer function indicating a relationship between a function X(s) of the complex number s and a function θ (s) of the complex number s is
$$[ Math . 1 ]$$
$$\frac{X ( s )}{θ ( s )} = ( 1 + \frac{{m}_{2}}{{m}_{0}} Ts ) \frac{v}{s} ,$$
a transfer function indicating a relationship between the function X(s) of the complex number s and the function U(s) of the complex number s is
$$[ Math . 2 ]$$
$$\frac{X ( s )}{U ( s )} = \frac{1 + \frac{{m}_{2}}{{m}_{0}} Ts}{1 + Ts} ,$$
a transfer function indicating a relationship between the function Z(s) of the complex number s and the function X(s) of the complex number s is
$$[ Math . 3 ]$$
$$\frac{Z ( s )}{X ( s )} = \frac{1}{1 + \frac{{m}_{2}}{{m}_{0}} Ts} ,$$
and T is a value obtained by dividing m₀ by a transport speed v of the label paper.

3. The printing apparatus according to claim 1, wherein
the detection unit is disposed between the first roller and the peeling plate.
